(19) United States
(12) Patent Application Publication
(10) Pub. No.: US 2005/0008342 A1
(43) Pub. Date: Jan. 13, 2005

(54) Multimedia player having the function of varying displayed contents in the suspending mode

(75) Inventor: Scot Lee, Hsin Tien City (TW)

Correspondence Address: DENNISON, SCHULTZ, DOUGHERTY & MACDONALD, 1727 KING STREET, SUITE 105, ALEXANDRIA, VA, 22314, US

(73) Assignee: VIA TECHNOLOGIES, INC.

(21) Appl. No.: 10/887,852

(22) Filed: Jul. 12, 2004

(30) Foreign Application Priority Data
Jul. 11, 2003 (TW) 92119067

(51) Int. Cl. H04N 5/91

(52) U.S. Cl. 386/113; 386/95

(57) ABSTRACT

A system and method is provided for displaying multimedia information used in suspending mode according to preset timing in a calendar. In one form, a real-time clock is used to generate a real-time clock signal so as to make the multimedia player being synchronous with the real world. A memory device is used to store encoded multimedia information while a calendar is still included therein for saving timing information set by the manufacturer and user. A data-accessing module is used to access corresponding multimedia information from the memory device according to a comparison result by comparing the timing information provided by the rear-time clock with the calendar. A decoder decodes the aforesaid multimedia before delivering to a display system.

### FIELD OF THE INVENTION

The present invention relates to a multimedia player, more particularly to a multimedia player having the function of varying displayed contents in the suspending mode.

### BACKGROUND OF THE INVENTION

Production of the multimedia player, such as a VCD or DVD player, brings a new fashion in the drawing room of human dwelling, which is generally known as home theater nowadays. In the past, people quench their thirst of enjoying the play or movie only at the movie house or at the theater, where tall screen with high performance audio-and-video systems are employed. Nowadays, home entertainment is enhanced by deployment of different multimedia players which include audio-and-video system with high performance.

FIG. 1 shows a block diagram of a prior art multimedia player that includes a data-accessing module 2, a decoder 4, a transmission interface 5, a display system 6 and a memory device 8. The multimedia player is provided with a disk-receiving compartment to receive an optical disk 9 for displaying. When the multimedia player is powered on, the data-accessing module 2 fetches the multimedia information encoded in the disk 9 upon detecting the presence of the optical disk within the disk-receiving compartment, and transmits the encoded multimedia information to the decoder 4. After being decoded by the decoder 4, the decoded multimedia information is transmitted via the transmission interface 5 so as to be displayed over the display system 6. On the other hand, upon detecting absence of the optical disk 9 within the disk-receiving compartment, the multiplayer will enter a suspend mode and the data-accessing module 2 will fetch the encoded multimedia information stored within the memory device 8. After being decoded, the multimedia information is displayed over the display system 6 during the suspending mode. The aforesaid multimedia information may be an advertisement or music or combination of both.

FIG. 2 shows the steps of displaying a multimedia information by the prior art multimedia player during the suspending mode. Step 10, the multimedia player is connected to a power source so as to be switched on. Step 12, the data-accessing module 2 detects presence of the optical disk 9 in the disk-receiving compartment. Step 120, confirmation is done to display the disk 9. Step 14, the multimedia information encoded within the disk 9 is displayed, accordingly. Step 121, when detecting absence of the disk 9 within the disk-receiving compartment 20, the data-accessing module 2 is disposed in a state to make a preparation. Step 16, the data-accessing module 2 fetches the preset information from the memory device 8. In step 18, the preset information is displayed over the display system 6 after being decoded i.e. after the multimedia player is powered on or prior to pressing the “play” button for starting an actual information (such as a movie). Listening to or watching the same preset information over and over again during the suspending mode is monotonous and subsequently brings discomfort to the audience. The waiting time before the main theme to be displayed over the display system 6 is generally known as suspending mode.

### SUMMARY OF THE INVENTION

The object of the present invention is to provide a multimedia player having the function of varying displayed contents in the suspending mode so as to overcome the aforesaid disadvantage.

In one aspect of the present invention, a multimedia player for displaying a multimedia information during a suspending mode is proposed and includes: a memory device for storing a plurality of encoded multimedia information, the memory device including a calendar for saving timing information; a data-accessing module for accessing a corresponding multimedia information from the memory device according to a comparison result by comparing the timing information with the calendar; a display system; and a transmission interface for transmitting the corresponding multimedia information so as to be displayed over the display system.

In a second aspect of the present invention, a method for varying displayed contents of a multimedia player during a suspending mode is proposed and includes the steps: comparing a real-time signal generated by a real-time clock module to a timing information with a calendar so as to result in a comparison result; accessing a multimedia information according to the comparison result; and displaying the multimedia information.

In a third aspect of the invention, a data-accessing system for a multimedia player is proposed. The multimedia player has the function of varying display contents in the suspending mode. The data-accessing system includes: a memory device for storing a plurality of encoded multimedia information, the memory device including a calendar for saving timing information; and a data-accessing module for accessing a corresponding multimedia information from the memory device according to a comparison result by comparing the timing information with the calendar.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a block diagram illustrating the components of a prior art multimedia player;

FIG. 2 is a block diagram illustrating the steps for displaying multimedia information by the prior art multimedia player;

FIG. 3 is a block diagram illustrating the components of a multimedia player according to the present invention; and

FIG. 4 is a block diagram illustrating the steps for displaying multimedia information during a suspending mode by the multimedia player of the present invention.

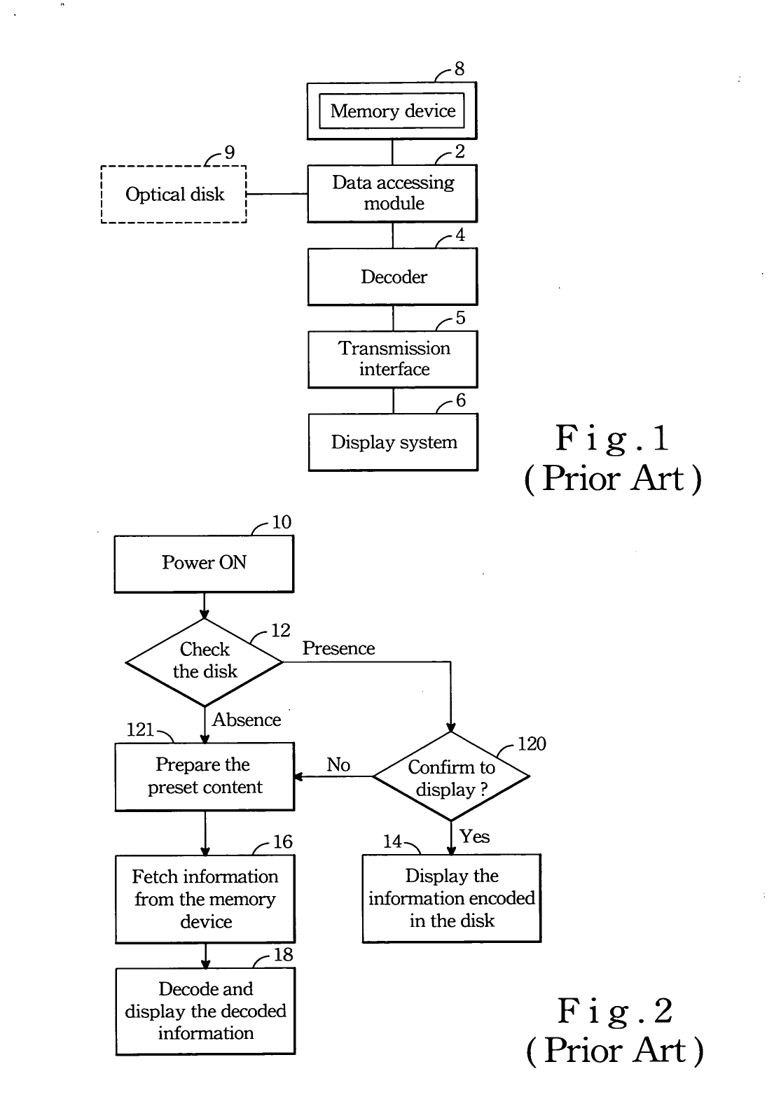

### DETAILED DESCRIPTION OF THE PREFERRED EMBODIMENT

The present invention provides a system for arranging a multimedia player to display a desired multimedia information (such as image or video/audio data) used in suspending mode according to preset timing in a calendar, i.e. prior to starting the main movie by the user. According to the present invention the user or the manufacturer can input a plurality of encoded multimedia information in advance into the multimedia player. The multimedia player can be preset in such a manner that the desired multimedia information (set by the user or the manufacturer) can be displayed at preset day and time during the suspending mode.

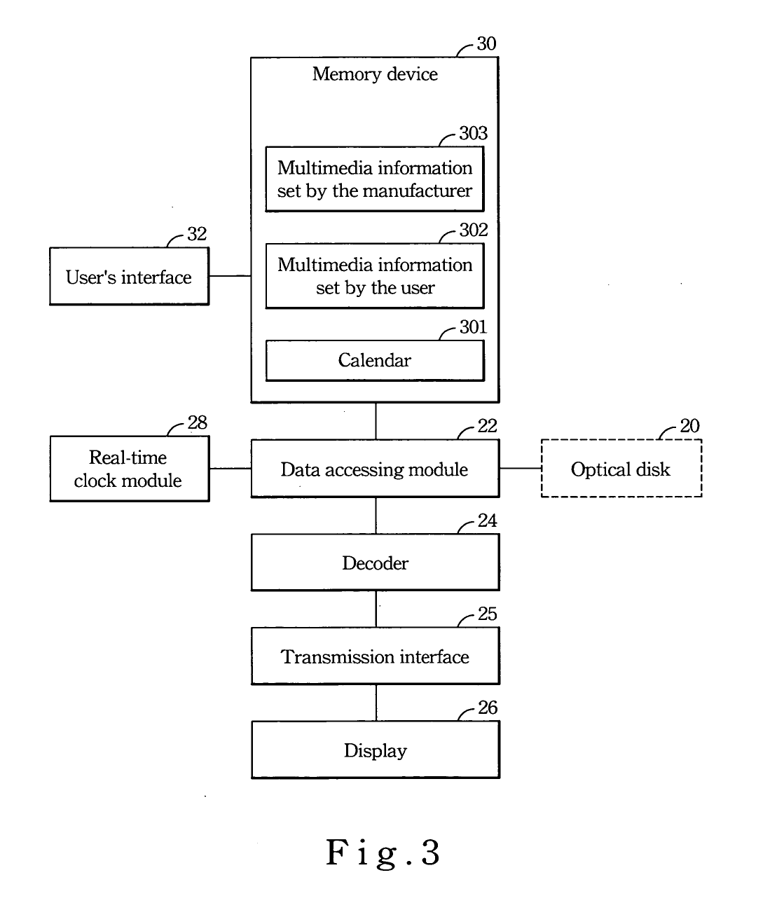

FIG. 3 is a block diagram of the preferred embodiment of a multimedia player (such as a DVD player) according to the present invention that includes a data-accessing module 22, a decoder 24, a transmission interface 25, a display system 26 (a TV set or an audio instrument), a real-time clock module 28, a memory device 30 and a user's interface 32. The real-time clock module 28 includes an oscillator and a timing circuit for generating real-time clock signal so as to make the multimedia player of the present invention being synchronous with the real world. The memory device 30 is used for storing a plurality of encoded multimedia information, which includes the multimedia information 303 preset by the manufacturer, and the multimedia information 302 inputted or programmed by the user via the optical disk 20 (such as CD, VCD, DVD), and a calendar 301 (for storing the timing information set by the user). Under this condition, the user can set up via the user's interface 32 (such as a remote control or a press button on the display panel of the DVD player) desired multimedia information to be displayed during the suspend mode. For example, the user can set up the multimedia player to display a start-up image with snowy background with a Christmas song on the 25th of December at a predetermined time. Alternatively, the user can input his or her date of birth and/or wedding into the multimedia player in such a manner to display a birthday song or a wedding rhythm in remembrance of his or her particular day for celebration. Such type of displaying the desired multimedia information rather than the multimedia information preset by the manufacturer during the suspend mode (the waiting time) is well known. Additionally, any person having ordinary skills in the art knows how to establish an environment that receives multimedia information inputted or programmed by users for the use during the suspend mode. For example, a specific button on a remote control may be configured to activate the mechanism that accepts multimedia information from the user for setting the displayed contents used in the suspend mode. A graphic user interface may be shown on the display system 26 to guide the user for settings. Thereafter, the user may select the displayed contents used for the suspend mode from a source. For example, he/she may select an image file or a video from the currently loaded optical disk or CF type (I or II) card. Associated timing for displaying the inputted displayed contents is then assigned via the shown user interface after the user decides his/her displayed contents. Finally, the multimedia player of the present invention may preview the displayed contents to the user according to his/her settings. After the user presses a button on the remote control for setting termination confirmation (the same button for actuating the aforementioned setup procedure may be used if possible), all settings including the displayed content and associated timing information may be stored into the memory device 30 and become a portion of the multimedia information 302 (the displayed contents used in the suspend mode) and calendar 301 (the assigned timing regarding the playback of the displayed contents). Please note that the aforementioned setting procedure may be varied as requirements or applications, but all similar modifications or variations within the spirits of the embodiment should be included in the scopes of the appended claims.

Note that during the setup operation of the start-up image and the desired multimedia information, he can select the information representing only the background view (only the snowy landscape) of the display panel set by the manufacturer while deleting the information representing the date and time (the Christmas or wedding celebration song). He can either select an entire specific multimedia information setup by himself so long as he does not depart from various arrangements included within the spirit and scope of the broadest interpretation of the present invention.

The data-accessing module 22 fetches the desired multimedia information from the memory device 30 according to a comparison result by comparing the timing information with the calendar 301. An important aspect to note is that the program codes that serves as a reference for conducting the comparing operation can be stored within (or outside) the data-accessing module 22 so long as the comparison result can be sent thereinto for further execution. The decoder 24 is capable of decoding the multimedia information fetched by the data-accessing module 22 and the decoded multimedia information is later delivered to the display system 26 (such as a TV set) via the transmission interface 25 for displaying. The memory device 30 can be selected from a group including an EEPROM (electrically erasable programmable read only memory) and a Flash memory. However, for those skilled in the art, other memory device in accordance with the required task of the user can replace the EEPROM or the Flash Memory.

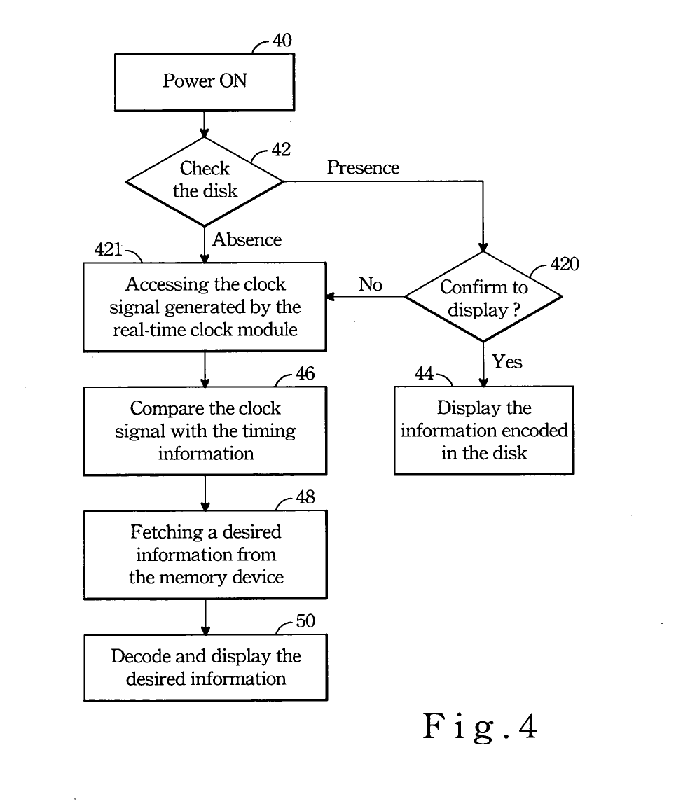

FIG. 4 illustrates the steps for displaying the desired multimedia information by the multimedia player of the present invention during the suspending mode according to preset time in a calendar. Step 40, the multimedia player is plugged into a power source so as to switch on the same. Step 42, the data-accessing module 22 checks the existence of the disk 20 within the multimedia player. Step 420, upon detecting presence of the disk 20, the user still needs to make a confirmation to display or not the multimedia information encoded within the disk 20. In step 44, the multimedia information will be displayed accordingly if the user confirms the signal. Step 421, in the event, the data-accessing module 22 cannot locate the existence of the disk 20 or the user does not choose the disk 20 despite of existence of the latter, the data-accessing module 22 fetches the clock signal 421 generated by the real-time clock module 28. Step 46, the clock signal is compared with the timing information of the calendar 301 to obtain a comparison result. Step 48, the data-accessing module 22 accesses the desired multimedia information from the memory device 30 according to the comparison result. In step 50, the desired multimedia information is displayed over the display system 26 after being decoded by the decoder 24, thereby completing the display action of the desired multimedia information at the preset day and time. In the event, the clock signal generated by the real-time clock module 28 matches the timing information with the calendar 301, the data-accessing module 22 will fetch the desired information set by the user from the memory device 30. The fetched multimedia information is then displayed over the display system 26 after being decoded by the decoder 50, thereby completing the display action of the multimedia information under the suspend mode.

Please note that the disclosed multimedia player according to the invention may show any kind of multimedia information for user's selections in Step 48. For example, one segment or a scene of specific multimedia information stored in the memory 30 may be shown over the display system 26 for user's selection. However, the multimedia information shown for user's selection may be all multimedia information currently stored in the memory 30, the parts which excludes the multimedia information inputted from the user (such as the multimedia information regarding Christmas or his/her wedding day), or all multimedia information stored in the memory device 30. Any ordinary person having skills in the art may modify the embodiment as different requirements or applications, but all similar modification or variations within the spirit of the embodiments should be included in the scopes of the appended claims.

In contrast to the prior art multimedia player, since the start-up image and the multimedia information to be displayed during the suspending mode can be varied according the user requirement, monotonous and discomfort feeling during waiting the start-up of the main information (such as movie) can be avoided.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A multimedia player for displaying multimedia information during a suspending mode, comprising:
a memory device for storing a plurality of encoded multimedia information, said memory device including a calendar for saving a specific time;
a data-accessing module for accessing a corresponding multimedia information from said memory device according to a comparison result by comparing a real-time clock signal with said specific time of the calendar;
a display system; and
a transmission interface for transmitting said corresponding multimedia information according to said comparison result so as to display said corresponding multimedia information over said display system.

2. The multimedia player according to claim 1 further comprising a real-time clock module for generating said real-time clock signal so as to make said multimedia player being synchronous with the real world.

3. The multimedia player according to claim 1 wherein said corresponding multimedia information set by a user is displayed over said displayed system when said comparison result indicates that said real-time clock signal substantially matches with said specific time of said calendar.

4. The multimedia player according to claim 1 wherein said corresponding multimedia information preset by a manufacturer of said multimedia player is displayed over said displayed system when said comparison result indicates that said real-time clock signal does not match with said specific time of said calendar.

5. The multimedia player according to claim 1 further comprising a user's interface via which a user can set said corresponding multimedia information and said specific time so as to display said corresponding multimedia information over said display system at said specific time during the suspending mode.

6. The multimedia player according to claim 1 further comprising an optical storage media, wherein said plurality of encoded multimedia information are inputted by a user via said optical storage media so as to be stored within said memory device.

7. The multimedia player according to claim 1 wherein said plurality of encoded multimedia information are inputted and stored within said memory device by a manufacturer of said multimedia player.

8. The multimedia player according to claim 1 further comprising a decoder which is adapted to decode said corresponding multimedia information into a decoded multimedia information so as to enable said transmission interface to transmit said decoded multimedia information to said display system.

9. A method for varying displayed contents of a multimedia player during a suspending mode, comprising:
comparing a real-time clock signal synchronous with the real world to a specific time of a calendar so as to result in a comparison result;
accessing a corresponding multimedia information according to said comparison result; and
displaying said accessed multimedia information.

10. The method according to claim 8 wherein said specific time and said corresponding multimedia information that is displayed at said specific time is set by a user.

11. The method according to claim 8 wherein said corresponding multimedia information set by a user is displayed when said comparison result indicates that said real-time clock signal substantially matches with said specific time.

12. The method according to claim 8 wherein said corresponding multimedia information preset by a manufacturer of said multimedia player is displayed when said comparison result indicates that said real-time clock signal does not match with said specific time.

13. A data-accessing system for a multimedia player which has a function of varying display contents in a suspending mode, said data-accessing system comprising:
a memory device for storing a plurality of encoded multimedia information, said memory device including a calendar for saving a specific time; and
a data-accessing module for accessing a corresponding multimedia information from said memory device according to a comparison result by comparing said specific time with a real-time clock signal synchronous with the real world.

14. The data-accessing system according to claim 13 wherein said corresponding multimedia information set by a user is displayed over said displayed system when said comparison result indicates that said real-time clock signal substantially matches with said specific time of said calendar.

15. The data-accessing system according to claim 13 wherein said corresponding multimedia information preset by a manufacturer of said multimedia player is displayed over said displayed system when said comparison result indicates that said real-time clock signal dose not matches with said specific time of said calendar.

16. The data-accessing system according to claim 13 further comprising a user's interface via which a user can input and set said corresponding multimedia information and said specific time so as to display said inputted corresponding multimedia information over said display system at said specific time during the suspending mode.

17. The data-accessing system according to claim 13 further comprising an optical storage media, wherein said plurality of encoded multimedia information are inputted by a user via said optical storage media so as to be stored within said memory device.

18. The data-accessing system according to claim 13 wherein said plurality of encoded multimedia information are inputted and stored within said memory device by a manufacturer of said multimedia player.

19. The data-accessing system according to claim 13 further comprising a decoder which is adapted to decode said corresponding multimedia information into a decoded multimedia information so as to enable said transmission interface to transmit said decoded multimedia information to said display system.

20. A method for varying displayed contents of a multimedia player during a suspending mode, comprising:
comparing a real-time clock signal synchronous with the real world to a specific time of a calendar;
displaying a corresponding multimedia information set by a user when said real-time clock signal substantially matches with said specific time; and
displaying a corresponding multimedia information preset by a manufacturer of said multimedia player when said real-time clock signal does not match with said specific time.
